(19) United States
(12) Patent Application Publication
(10) Pub. No.: US 2009/0004062 A1
(43) Pub. Date: Jan. 1, 2009

(54) DEVICES FOR IMPROVING THE FLATNESS OF HIGH-DENSITY MICROPLATES

(75) Inventors: Gary Lim, San Francisco, CA (US); Donald Sandell, San Jose, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: APPLERA CORPORATION, Foster City, CA (US)

(21) Appl. No.: 11/769,784

(22) Filed: Jun. 28, 2007

(51) Int. Cl. B01L 11/00

(52) U.S. Cl. 422/99

(57) ABSTRACT

Methods and apparatuses that improve the flatness of the microplates. In some embodiments, a pair of opposing channels that extends along a length of a rigid member is used to retain the microplate on the rigid member and to impart a level of flatness of at least a predetermined value. In some embodiments, one or more rigid framing members each having a channel therein are disposed along the edges of a microplate and impart a level of flatness of at least a predetermined value to the microplate. In some embodiments, a method of flattening the microplate comprises securing the microplate to a rigid member so the microplate has a flatness of at least a predetermined value and maintaining the microplate secured to the rigid member during a subsequent spotting or filling operation.

### INTRODUCTION

The present teachings relate to methods and apparatuses that improve the flatness of microplates.

Microplates are used in spotting or filling work stations wherein the microwells receive assays, reagents and/or samples. The microplates may conform to SBS/ANSI (Society for Biomolecular Screening/American National Standards Institute) standard dimensions and may be about 127 millimeters in length by about 85 millimeters in width. The microplate may include a plurality of wells. For example, some microplates can have 6,144 wells or more. The small size and compact spacing of the wells makes the precise alignment of the wells on a spotting or filling work station difficult. While the microplate is typically manufactured to precise dimensions, the level of flatness can deviate from the nominal value to an extent that can lead to dispensed assays, reagents and/or samples missing their targeted wells.

The present teachings provide methods and apparatuses that improve the flatness of the microplates. In some embodiments of the present teachings, a pair of opposing channels that extends along a length of a rigid member is used to retain the microplate on the rigid member and to impart a level of flatness of at least a predetermined value. In some embodiments of the present teachings, one or more rigid framing members each having a channel therein are disposed along the edges of a microplate and impart a level of flatness of at least a predetermined value to the microplate. In some embodiments of the present teachings, a method of flattening the microplate comprises securing the microplate to a rigid member so the microplate has a flatness of at least a predetermined value and maintaining the microplate secured to the rigid member during a subsequent spotting or filling operation. These and other features of the present teachings are set forth herein.

### DRAWINGS

The skilled artisan will understand that the drawings, described below, are for illustration purposes only. The drawings are not intended to limit the scope of the present teachings in any way.

FIG. 1 is a simplified view of a spotting or filling work station employing a flattening device according to the present teachings;

FIG. 2 is an exploded view of a flattening device according to the present teachings disposed between a microplate and an instrument deck;

FIG. 3A is a perspective view of the flattening device of FIG. 2;

FIG. 3B is an exploded bottom view of the flattening device of FIG. 3A;

FIG. 4 is a bottom plan view of an alternate version of the flattening device of FIG. 2;

FIG. 5A is a top perspective view of a flattening device according to the present teachings which is incorporated into an instrument deck and shown having a microplate thereon;

FIG. 5B is a top plan view of the flattening device of FIG. 5A with the microplate thereon;

FIG. 5C is a top plan view of the flattening device of FIG. 5B with the microplate removed;

FIG. 5D is a cross-sectional view of the flattening device of FIG. 5C along line 5D-5D;

FIG. 6A is a perspective view of another flattening device according to the present teachings showing a fragmented microplate being attached thereto;

FIG. 6B is a cross-sectional view of the flattening device of FIG. 6A along line 6B-6B;

FIG. 7 is a flow chart of a method of using the flattening device of FIGS. 6A and B;

FIG. 8A is an exploded perspective view of another flattening device according to the present teachings illustrated around a microplate;

FIG. 8B is a perspective view of a longitudinal framing member of the flattening device of FIG. 8A;

FIG. 8C is a perspective view of a lateral framing member of the flattening device of FIG. 8A; and

FIG. 9 is a flow chart of a method of using the flattening device of FIGS. 8A-C.

### DESCRIPTION OF VARIOUS EMBODIMENTS

The present teachings provide methods and apparatuses for improving the flatness of high-density microplates. The following definitions and non-limiting guidelines must be considered in reviewing the description of the invention set forth herein.

The section headings used herein are used for organizational purposes only and are not to be construed as limiting the subject matter described in any way. Furthermore, while the present teachings are described in conjunction with various embodiments, it is not intended that the present teachings be limited to such embodiments. On the contrary, the present teachings encompass various alternatives, modifications and equivalents, as will be appreciated by those of skill in the art.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features. Specific examples are provided for illustrative purposes of how to make, use and practice the devices and methods of these teachings and, unless explicitly stated otherwise, are not intended to be a representation that given embodiments of these teachings have, or have not, been made or tested.

As used herein, the word “include” and its variants are intended to be non-limiting, such that recitation of items in a list is not to the exclusion of other like items that may also be useful in the materials, compositions, devices and methods of these teachings.

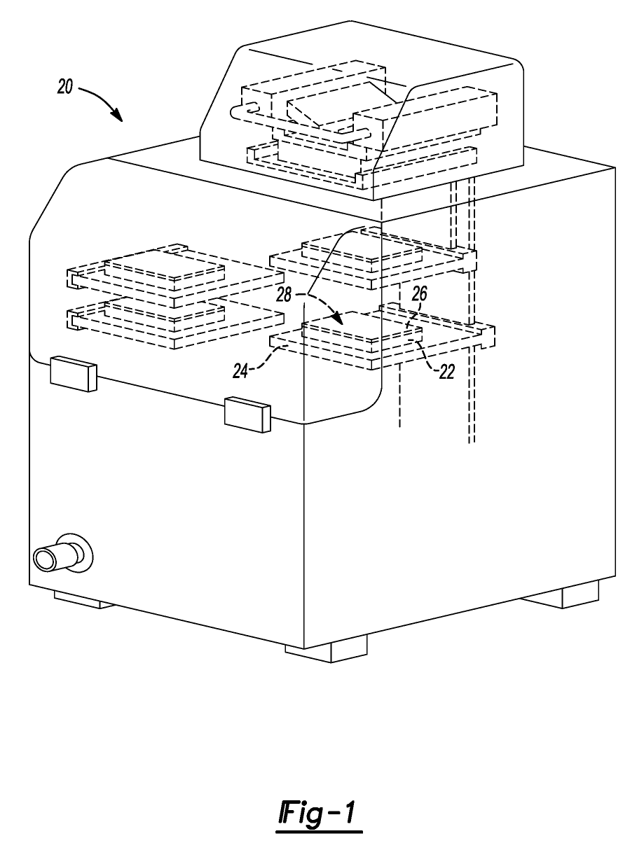

Referring to FIG. 1, a representative spotting or filling work station 20 employing a flattening device 22 according to the present teachings is shown. Flattening device 22 can be attached to an instrument deck 24 of work station 20 and can retain a microplate 26 (also “plate”) thereon. Flattening device 22 along with the other flattening devices disclosed herein can impart a level of flatness to microplate 26 that can be equal to or better than a predetermined value, such as but not limited to a total flatness equal to or better than 500 microns or a nominal value ±250 microns or less, thereby enabling the microwells in microplate 26 to be precisely located and easily accessed by work station 20. Flattening device 22 can compensate for out-of-flat conditions of microplate 26 which can lead to dispensed reagents and samples missing their targeted microwells on microplate 26. Thus, the use of flattening device 22 can enable precise positioning of microplate 26 relative to instrument deck 24 thereby facilitating the spotting and filling operations.

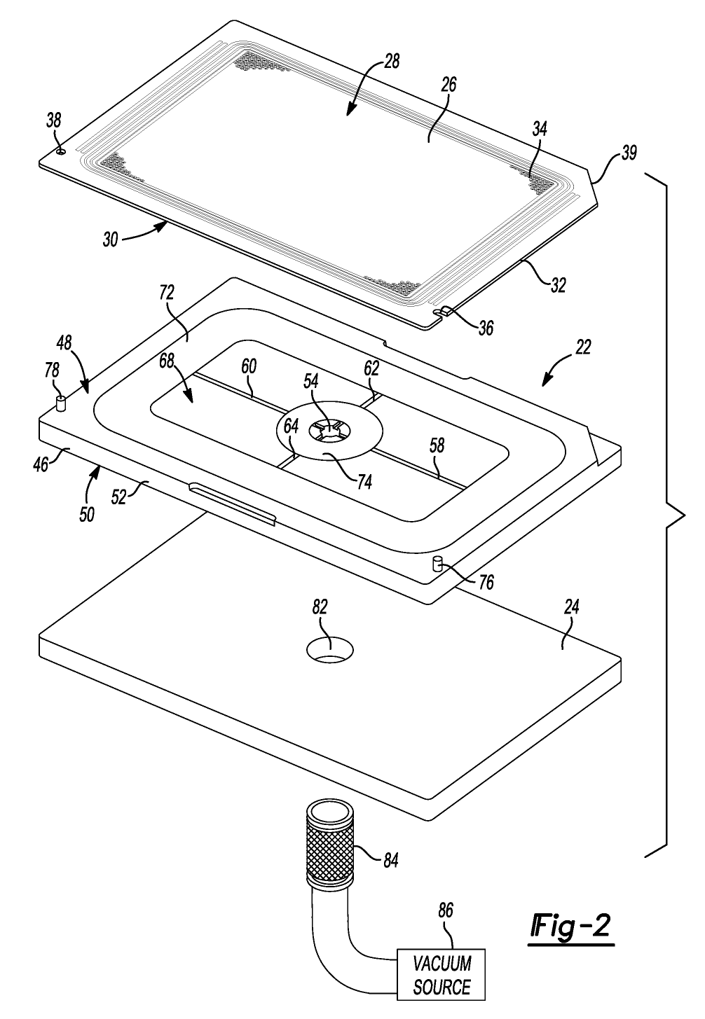

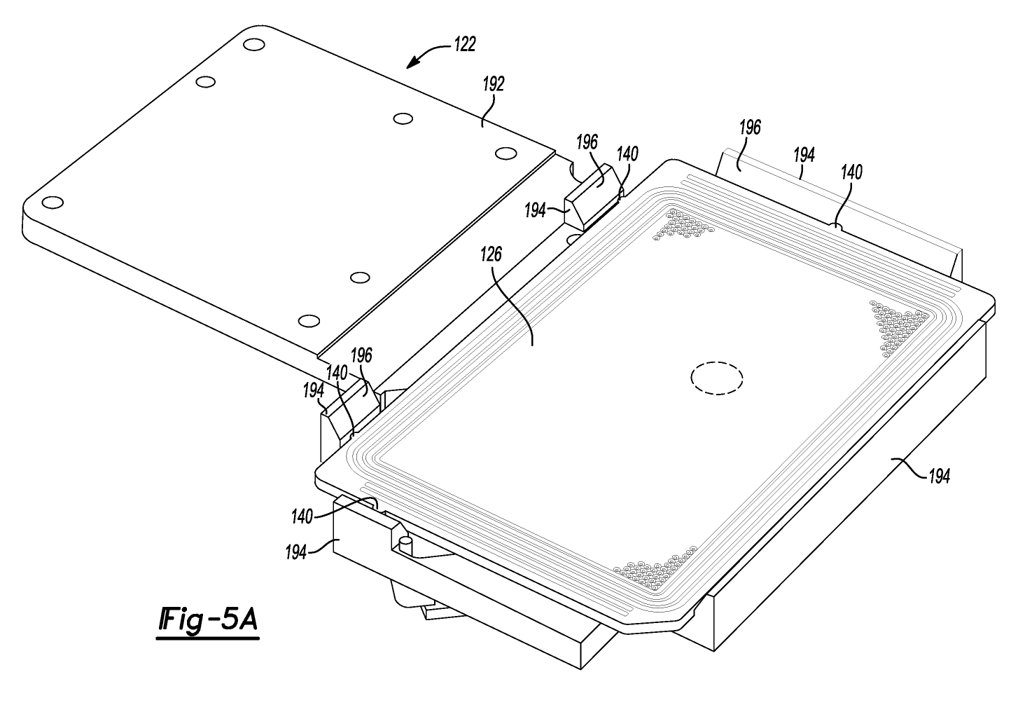

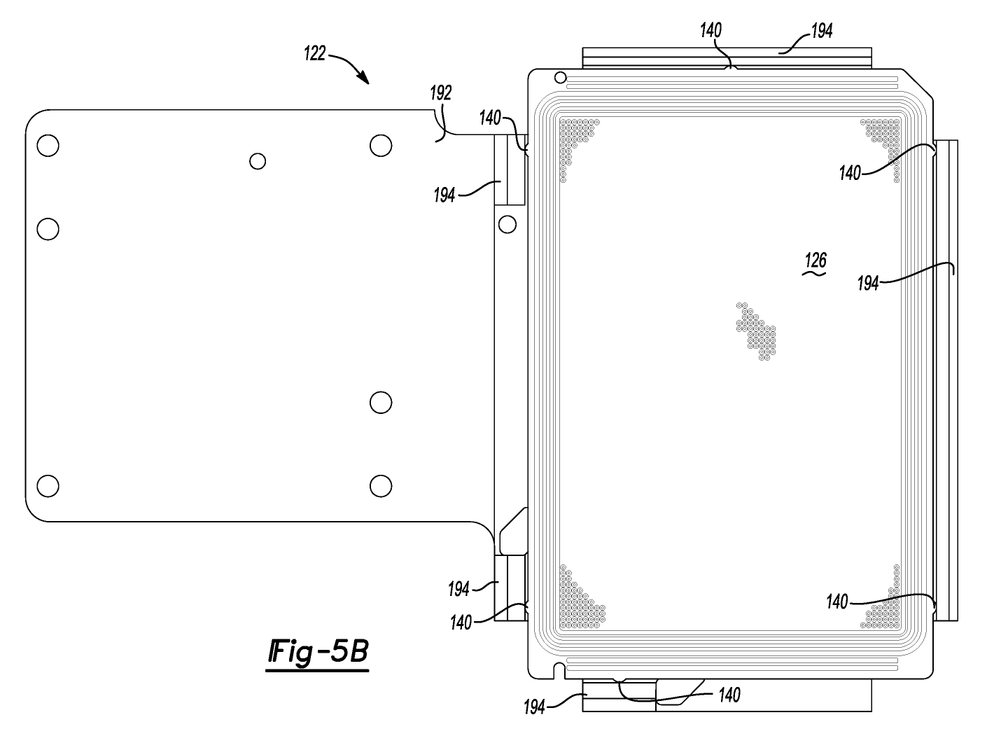

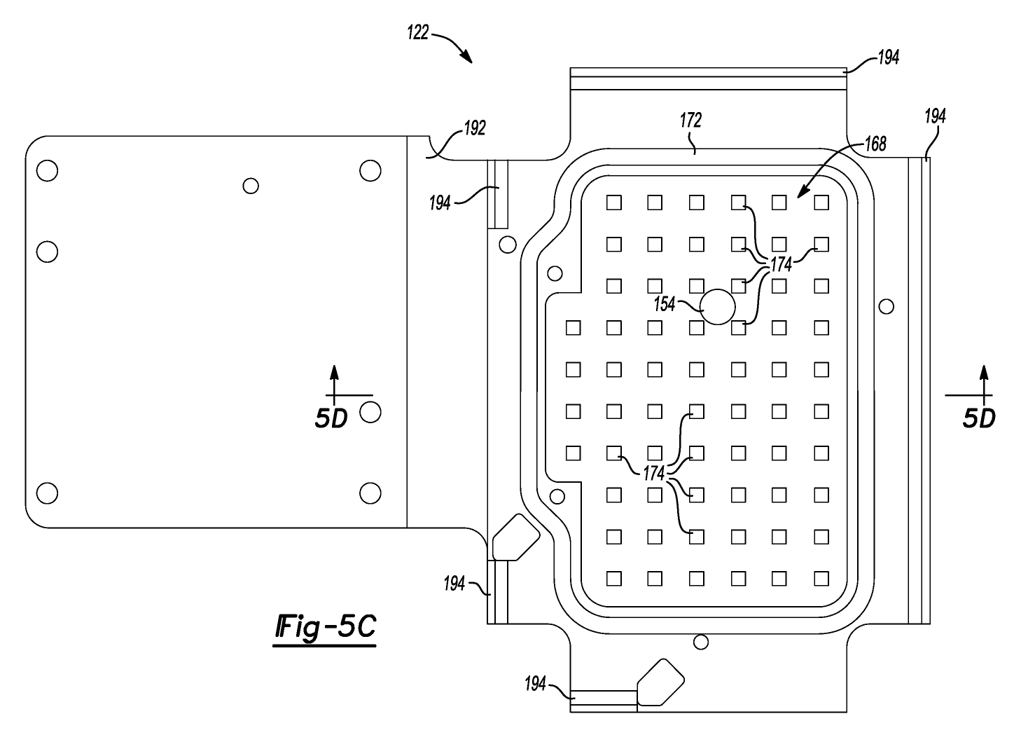

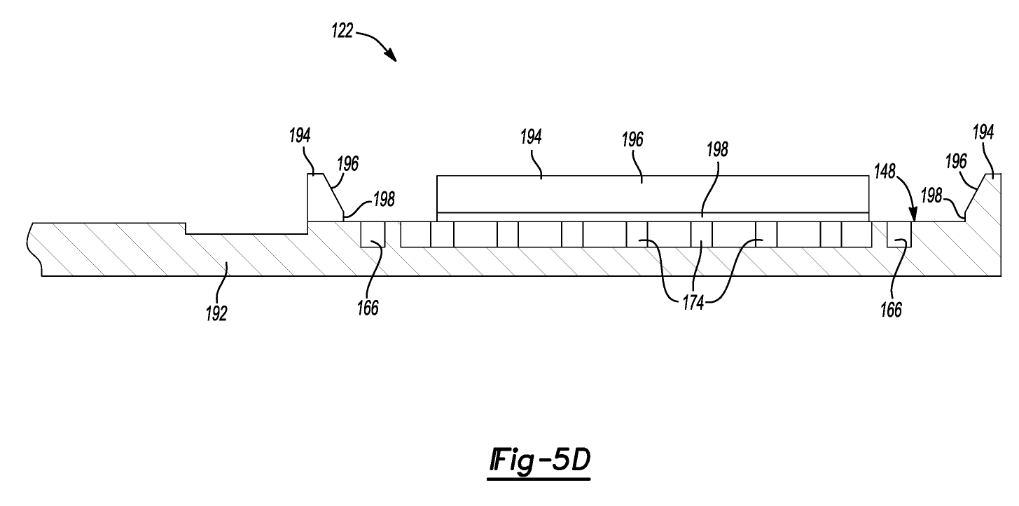

Microplates 26, for which flattening device 22 is configured to retain, have opposite first (upper) and second (bottom) surfaces 28, 30 and a sidewall 32 therebetween, as can be seen in FIG. 2. First surface 28 can include a plurality of microwells 34 therein. Microwells 34 can receive assays, reagents and/or samples by a spotting or filling work station 20. Second surface 30 of microplate 26 is substantially planar and flat. Alignment features, in this case in the form of a slot 36 in sidewall 32 and an aperture 38 adjacent sidewall 32, can be used to align microplate 26 on flattening device 22, as described in more detail below. In some embodiments, such as that shown in FIG. 5B, a plurality of nubs or projections 140 that extend outwardly from sidewall 32 can be used to align microplate 26, as described in more detail below. It should be appreciated that alignment features other than those shown and/or discussed can be used with microplate 26. For example, the beveled corner 39 on microplate 26 can also be used as an alignment feature.

Microplate 26 can be made from a plastic such as polypropylene with graphite filler. It should be appreciated, however, that other materials such as, but not limited to, glass, silica, plastics, thermal conductive materials, and any other material useful to those skilled in the art can be used for microplate 26. The small size and compact spacing of microwells 34 can make the precise alignment of microwells 34 on a spotting or filling work station 20 difficult. In some embodiments, microplate 26 conforms to SBS/ANSI standard dimensions and is about 127 mm in length by about 85 mm in width. In some embodiments, microplate 26 can have at least 6,144 microwells. While microplate 26 is manufactured to precise dimensions, the level of flatness of microplate 26 can deviate from the nominal value an extent that can lead to dispensed reagents and samples missing their targeted microwells 34.

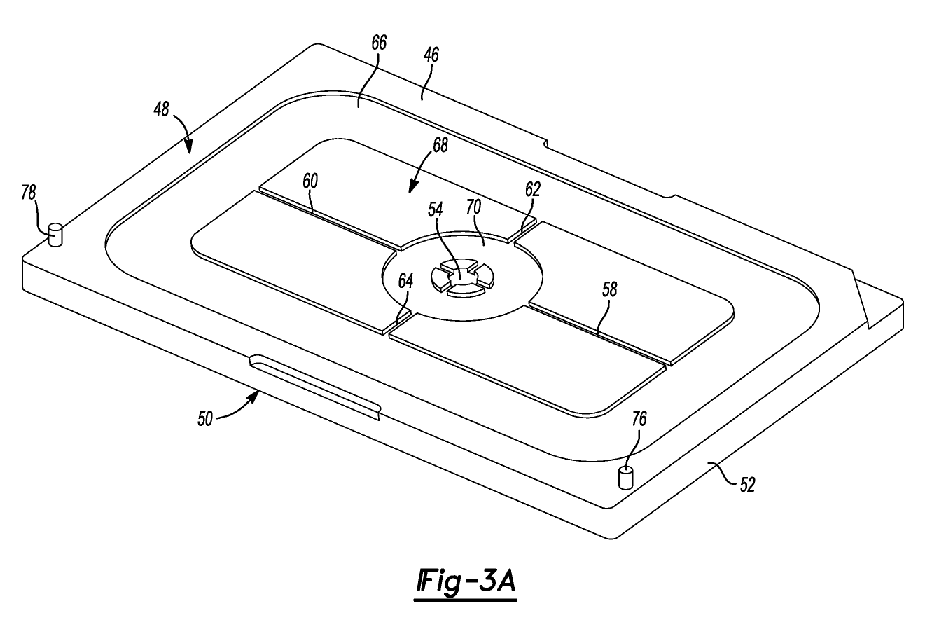

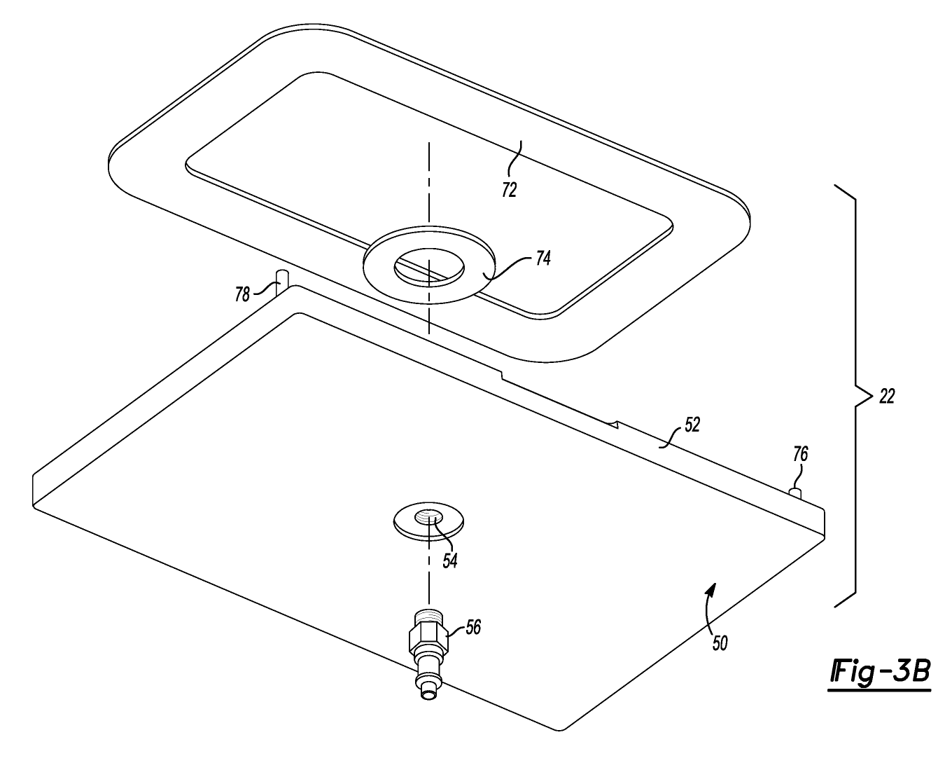

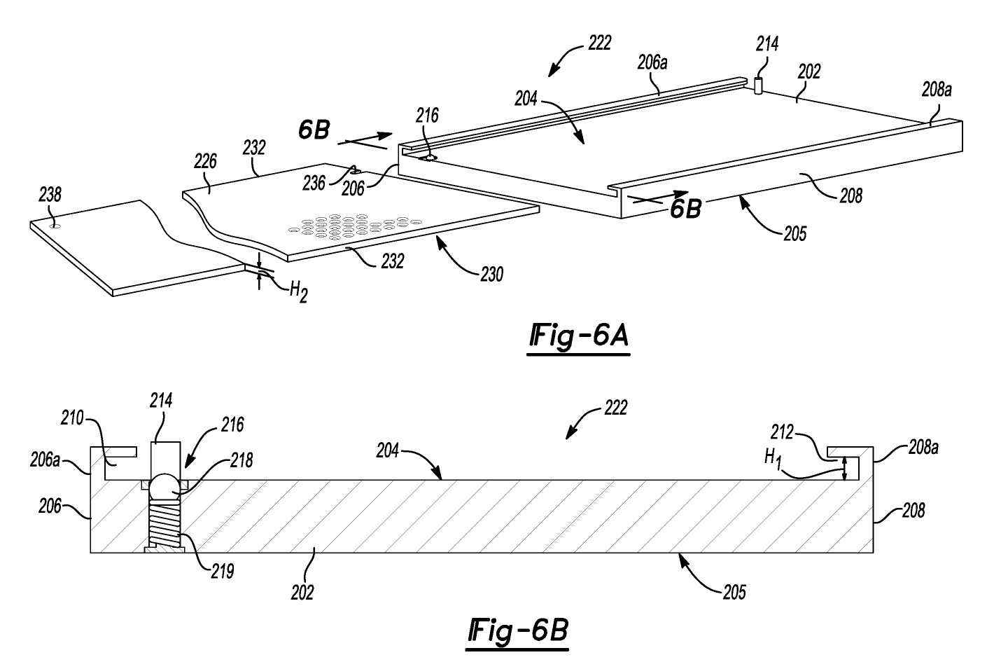

Flattening device 22 is operable to improve the flatness of microplate 26 to a level that can allow for precise alignment on spotting or filling work station 20 so that the reagents and samples can be accurately placed in the desired well. In some embodiments shown in FIGS. 2, 3A-B, 4 and 5A-D, a vacuum can be applied to retain microplate 26 to flattening device 22. The vacuum can impart a force on microplate 26 that in conjunction with other aspects of flattening device 22 causes microplate 26 to achieve a level of flatness equal to or better than a predetermined value, as described below. In some embodiments, as shown in FIGS. 6A-B and 8A-C, the flattening device can mechanically improve the flatness of microplate 26 without the use of a vacuum, as described below.

Referring now to FIGS. 2 and 3A-B, flattening device 22 can use a rigid microplate or chuck 46 having opposite first and second surfaces 48, 50 and a sidewall 52 therebetween. Chuck 46 can be precisely dimensioned to allow indexing off a portion of sidewall 52 to align on an instrument deck 24 of a work station 20. If desired, chuck 46 can include alignment features that correspond with complementary alignment features on instrument deck 24 to align chuck 46 on instrument deck 24 in a desired position and orientation. In some embodiments, chuck 46 can have a footprint about the size of a microtiter or microplate conforming to SBS/ANSI dimensional standards. In other embodiments, chuck 46 can have a footprint of a differing size. Chuck 46 can be more rigid than microplate 26 to allow chuck 46 to improve the flatness of microplate 26. Chuck 46 can be made from a variety of materials. For example, materials from which chuck 46 can be made include steel, aluminum or other metals or materials including polymers.

Chuck 46 can include a central aperture 54 which extends between first and second surfaces 48, 50. A vacuum fitting 56 can be attached to chuck 46 and can extend from second surface 50. Fitting 56 can communicate with aperture 54 to allow a vacuum source to be connected to chuck 46, as described below.

Two recessed fluid channels 58, 60 can extend longitudinally along first surface 48 of chuck 46. Two other recessed channels 62, 64 can extend laterally along first surface 48 of chuck 46. Fluid channels 58, 60, 62, 64 can all communicate with aperture 54 to allow a vacuum to be pulled between microplate 26 and first surface 48 of chuck 46 to retain microplate 26 in place and improve the flatness, as described below.

As seen in FIG. 3A, a first recessed retaining channel 66 in first surface 48 of chuck 46 can circumscribe aperture 54 and can extend adjacent sidewall 52. Retaining channel 66 can define a region 68 on first surface 48 of chuck 46 within which the vacuum can be imparted to hold microplate 26 on chuck 46 and improve the flatness, as described below. Fluid channels 58, 60, 62, 64 can terminate at or in retaining channel 66. A second recessed retaining channel 70 can be in first surface 48 of chuck 46 and can circumscribe aperture 54 within region 68. Fluid channels 58, 60, 62 and 64 can extend through retaining channel 70 as they extend toward retaining channel 66.

As seen in FIGS. 2 and 3B, a sealing member 72 can be disposed in first retaining channel 66 and a support member 74 can be disposed in second retaining channel 70. Sealing member 72 and support member 74 can protrude above first surface 48 of chuck 46. Sealing member 72 can provide a vacuum-tight seal against second or bottom surface 30 of microplate 26 and can enable a vacuum to be maintained in region 68 to hold microplate 26 to chuck 46 and improve the flatness. Sealing member 72 can be resilient and made from a variety of materials. For example, such materials for sealing member 72 can include an elastomer or other resilient material.

Support member 74 can provide a support surface for the bottom or second surface 30 of microplate 26. Support member 74 can limit deformation of microplate 26 due to the force of the vacuum between chuck 46 and microplate 26. Support member 74 can be a stiff or rigid support or a resilient support that undergoes some deformation due to the force of the vacuum between microplate 26 and chuck 46. As such, support member 74 can be a non-deformable gasket, O-ring or the like, or also function as a sealing member providing a fluid-tight seal between microplate 26 and chuck 46 and made from an elastomer or other resilient material.

Fluid channels 58, 60, 62, 64 can extend beneath support member 74 and can allow a vacuum to be imparted in region 68 of chuck 46 both inside and outside of support member 74. Sealing member 72, support member 74 and first surface 48 of chuck 46 can be dimensioned to provide a planar surface having a flatness equal to or better than a predetermined value when microplate 26 is being held thereon by a vacuum. The vacuum can cause microplate 26 to deform from its nominal dimensions and can result in the predetermined level of flatness, or better, to be imparted to microplate 26. The number of support members 74 and/or sealing members 72 can be increased or decreased to provide a required level of support to the bottom or second surface 30 of microplate 26 to impart a desired level of flatness to microplate 26. Furthermore, the width of sealing member 72 and/or support member 74 can be changed to provide a desired level of support to bottom or second surface 30 of microplate 26. The predetermined level of flatness can be chosen to allow precise positioning of microplate 26 on chuck 46 and subsequently on instrument deck 24 to allow for accurate spotting and/or filling operations by work station 20. By way of non-limiting example, a total flatness equal to or better than 500 microns or a nominal value ±250 microns or less can be the predetermined flatness level imparted by chuck 46 to microplate 26.

Chuck 46 can include alignment features to facilitate the alignment of microplate 26 on chuck 46. In some embodiments, as shown in FIGS. 2, 3A-B and 4, the alignment features include pins 76, 78 in the corners of first surface 48 of chuck 46. Pins 76, 78 can extend from first surface 48 and can respectively engage with slot 36 and aperture 38 on microplate 26. microplate 26 can be positioned on first surface 48 of chuck 46 with pin 78 extending into aperture 38. As microplate 26 is moved into planar alignment with first surface 48, pin 78 can engage with slot 36. The engagement of pins 76, 78 with slot 36 and aperture 38 can align microplate 26 precisely on chuck 46.

Instrument deck 24, as shown in FIG. 2, can have an opening 82 through which fitting 56 on chuck 46 fits when chuck 46 is positioned on instrument deck 24. Fitting 56 on chuck 46 can connect to a complementary fitting 84 that communicates with a vacuum source 86. Fittings 56, 84 can be of any known type that allows fluid communication therebetween. Fittings 56, 84 can be quick-connect fittings that allow quick and easy connection and disconnection to/from vacuum source 86. Vacuum source 86 can be internal or external to work station 20. For example, a vacuum pump that is part of work station 20 can be used. The connection of vacuum source 86 to chuck 46 via fittings 56, 84 can enable a vacuum to be formed in region 68 between first surface 48 of chuck 46 and bottom surface 30 of microplate 26. When vacuum source 86 is activated, the vacuum can pull microplate 26 against first surface 48, sealing member 72 and support member 74 and can impart a flatness to microplate 26 equal to or better than the predetermined value.

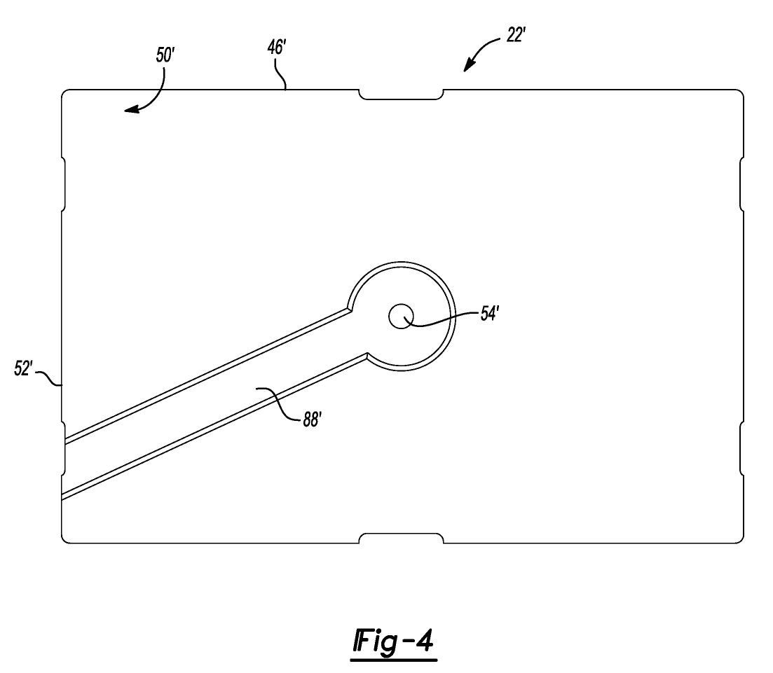

On instrument decks 24 without opening 82 therein, the chuck can have a different arrangement to account for the lack of the opening in the instrument deck. In some embodiments, as shown in FIG. 4, a chuck 46′ can have a second surface 50′ with a recessed channel 88′. Channel 88′ can extend from aperture 54′ to sidewall 52′. A recessed fitting (not shown) can be attached to aperture 54′ and can be dimensioned to not protrude beyond second surface 50′ of chuck 46′. A hose or conduit connected to a vacuum source can be routed through channel 88′ and can be connected to the recessed fitting in aperture 54′. In this manner, chuck 46′ can be positioned on a flat surface of an instrument deck and still be connected to a vacuum source to enable a vacuum to be imparted between a microplate and the chuck to retain the microplate thereon.

Referring now to FIGS. 5A-D, in some embodiments the flattening device 122 can be integrated into the instrument deck and can form an integrated chuck/deck 192. In these embodiments, the dimensions and shape of flattening device 122 can be dictated by the specific work station for which flattening device 122 is configured to be used with. Flattening device 122 can use a vacuum to retain microplate 126.

As shown in FIG. 5C, support member 174 can take the form of a plurality of projections that extend upwardly from region 168 of integrated chuck/deck 192. Support members 174 can be arranged in a variety of patterns, as needed, to provide support for the bottom surface of microplate 126 to prevent undesirable or unwanted deformation of microplate 126 when subjected to the vacuum. Support members 174, in these embodiments, do not circumscribe aperture 154. With these embodiments, fluid channels may not be needed in integrated chuck/deck 192 to allow the vacuum to be imparted throughout region 168. Sealing member 172 can circumscribe aperture 154 and can provide a fluid-tight seal between microplate 126 and integrated chuck/deck 192.

Integrated chuck/deck 192 can use the same alignment features discussed above with reference to FIGS. 2 and 3A-B or, as shown in FIGS. 5A-5D, can use a plurality of walls or projections 194 that can extend outwardly from first surface 148 of integrated chuck/deck 192. As seen in FIG. 5D, walls 194 can include a tapered portion 196 and a vertical portion 198 that can extend orthogonally from first surface 148 of integrated chuck/deck 192. Nubs 140 (FIGS. 5A and 5B) on microplate 126 can engage with tapered portions 196 and vertical portions 198 as microplate 126 is positioned on integrated chuck/deck 192. The tapered portions 196 can facilitate the placement of microplate 126 on integrated chuck/deck 192 while vertical portions 198 can provide precise alignment of microplate 126 on integrated chuck/deck 192 via interaction with nubs 140.

In some embodiments according to the present teachings, a flattening device 222 comprises a flattening block 202, as shown in FIGS. 6A and B. Flattening block 202 can compensate for out-of-flat conditions of microplate 226 which can lead to dispensed reagents and samples missing the targeted microwells on microplate 226. Thus, the use of flattening block 202 can enable precise positioning of microplate 226 relative to an instrument deck thereby facilitating spotting and/or filling operations.

Flattening block 202 can mechanically retain microplate 226 and can impart a predetermined level of flatness or better to microplate 226. Flattening block 202 can be a rigid member having a rigidity greater than that of microplate 226. Flattening block 202 can be made from a variety of materials including steel, aluminum, or other metals or materials, such as polymers. Flattening block 202 can be precisely dimensioned to allow indexing off a portion of flattening block 202, such as, by way of non-limiting example, the side wall, to align on an instrument deck of a work station. If desired, flattening block 202 can include alignment features that correspond with complementary alignment features on the instrument deck to align flattening block 202 on the instrument deck. In some embodiments, flattening block 202 can have a footprint the size of a microtiter microplate conforming to SBS standards. In some embodiments, flattening block 202 can have a footprint of a differing size. Flattening block 202 can have a top surface 204 that has a flatness of the predetermined level of flatness or better. Top surface 204 can support bottom surface 230 of microplate 226 when positioned on flattening block 202.

Flattening block 202 can comprise opposite top and bottom surfaces 204, 205 with longitudinally extending sidewalls 206, 208 extending therebetween. Bottom surface 205 can be flat and can engage with the instrument deck. Opposing side extensions 206a, 208a of opposing sidewalls 206, 208 of flattening block 202 can extend above top surface 204. Extensions 206a, 208a in conjunction with portions of top surface 204 can form opposing U-shaped channels 210, 212. The openings in channels 210, 212 can face one another. Channels 210, 212 can receive sidewalls 232 of microplate 226 therein. Channels 210, 212 can have an internal vertical height H₁ that can be dimensioned to be slightly larger than the nominal thickness H₂ of sidewalls 232 of microplate 226 and to impart the predetermined level of flatness or better to microplate 226. In some embodiments, height H₁ can equal the nominal thickness H₂+500 microns or less. In some embodiments, height H₁ can impart a level of flatness of the nominal thickness H₂±250 microns.

To attach microplate 226 to flattening block 202, microplate 226 can be slid along top surface 204 with opposing sidewalls 232 disposed in channels 210, 212. The dimensions of channels 210, 212 can be selected to impart the flatness of a predetermined level or better. Channels 210, 212 can have a height H₁ that can deform microplate 226, as needed, as microplate 226 is slid along top surface 204 with opposing sidewalls 232 disposed in channels 210, 212. The deformation of microplate 226 by channels 210, 212 can cause microplate 226 to have a level of flatness, at least in the direction parallel to channels 210, 212, to be equal to or better than the predetermined level of flatness. If microplate 226 already has a level of flatness, at least in the direction parallel to sidewalls 232, equal to or better than the predetermined level of flatness, channels 210, 212 may not deform microplate 226 when being inserted into flattening block 202. In some embodiments, the predetermined level of flatness can be 500 microns total or a nominal value ±250 microns.

Flattening block 202 can include alignment features that can facilitate the alignment of microplate 226 thereon. The alignment features can include channels 210, 212, an alignment pin 214 and a plunger mechanism 216. Channels 210, 212 can transversely align microplate 226 on flattening block 202 and can guide microplate 226 as it is slid along top surface 204 of flattening block 202. Pin 214 can engage with slot 236 of microplate 226 to limit the distance along top surface 204 that microplate 226 can be slid and can thereby longitudinally align microplate 226 on flattening block 202. Plunger mechanism 216 can comprise a ball 218 that can nominally extend slightly above top surface 204. A spring 219 can bias ball 218 to its nominal position and can allow ball 218 to be plunged into and retracted below top surface 204 when subjected to a force of an appropriate magnitude. When microplate 226 is slid along top surface 204, bottom surface 230 of microplate 226 can push ball 218 below top surface 204. As slot 236 in microplate 226 comes into full engagement with pin 214, ball 218 can align with aperture 238 in microplate 226. Spring 219 can cause ball 218 to extend upwardly and into engagement with aperture 238. Plunger mechanism 216 can retain microplate 226 in this orientation on top surface 204 of flattening block 202. To remove microplate 226 from flattening block 202, a sliding force of a sufficient magnitude can be imparted upon microplate 226 to overcome the biasing of ball 218 by spring 219. Flattening block 202 can thereby retain microplate 226 thereon and can impart a level of flatness to microplate 226 equal to or better than the predetermined level of flatness through the interaction with channels 210, 212 and top surface 204.

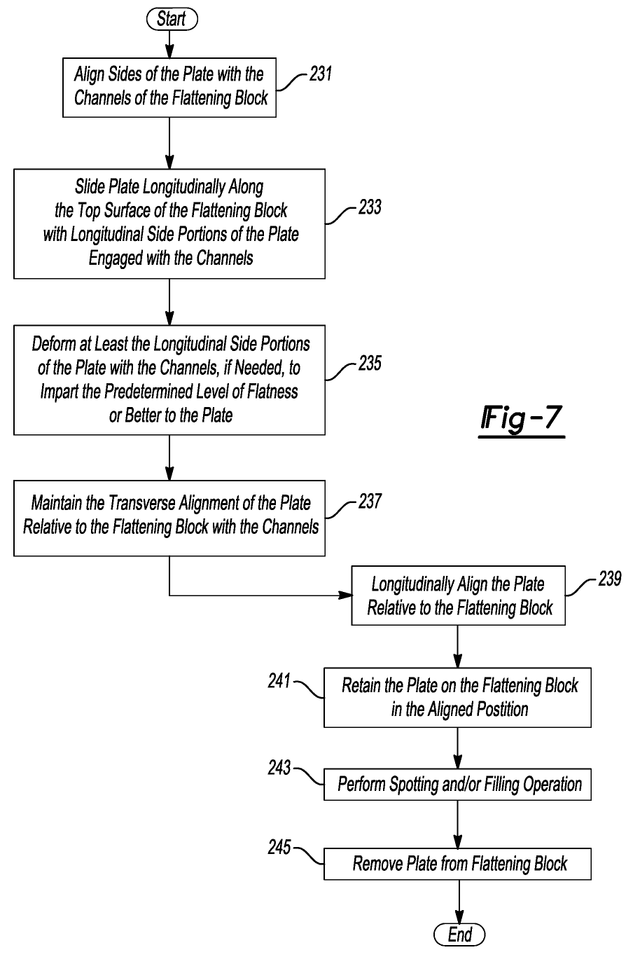

Referring to FIG. 7, a method of using flattening block 202 to impart a predetermined level of flatness to microplate 226 is illustrated. The method can begin with aligning sidewalls 232 of microplate 226 with channels 210, 212 of flattening block 202, as indicated in block 231. Microplate 226 can then be slid longitudinally along top surface 204 of flattening block 202 with longitudinal side portions of microplate 226 engaged with channels 210, 212, as indicated in block 233. As microplate 226 is slid along top surface 204, the interaction between channels 210, 212 and top surface 204 of flattening block 202 can cause at least the longitudinal portions of microplate 226 adjacent sidewalls 232 to be deformed, if needed, to impart the predetermined level of flatness or better to microplate 226, as indicated in block 235.

During the sliding and deforming phases, transverse alignment of microplate 226 relative to flattening block 202 can be maintained with the interaction of channels 210, 212 with sidewalls 232 of microplate 226, as indicated in block 237. Microplate 226 can be longitudinally aligned relative to flattening block 202, as indicated in block 239, by engaging complementary alignment features on microplate 226 and flattening block 202, such as engaging slot 236 with pin 214. microplate 226 can be retained on flattening block 202 in the aligned position, as indicated in block 241. microplate 226 can be retained on flattening block 202 by engaging ball 218 of plunger mechanism 216 with aperture 238 in microplate 226.

With microplate 226 having the predetermined level of flatness or better and aligned and retained on flattening block 202, a spotting and/or filling operation can be performed, as indicated in block 243. Once the spotting and/or filling operation is completed, microplate 226 can be removed from flattening block 202, as indicated in block 245. Thus, flattening block 202 according to the present teachings can be used to impart a predetermined level of flatness or better to microplate 226 and can facilitate the performing of a spotting and/or filling operation.

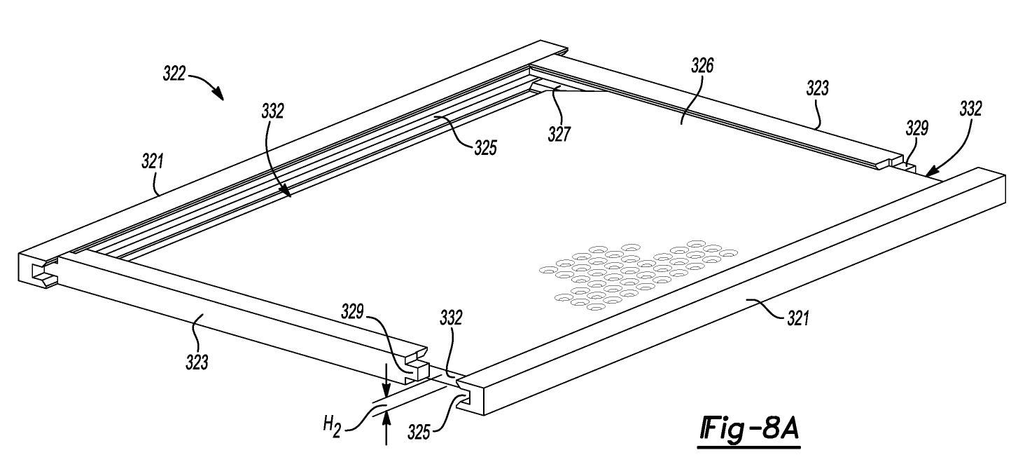

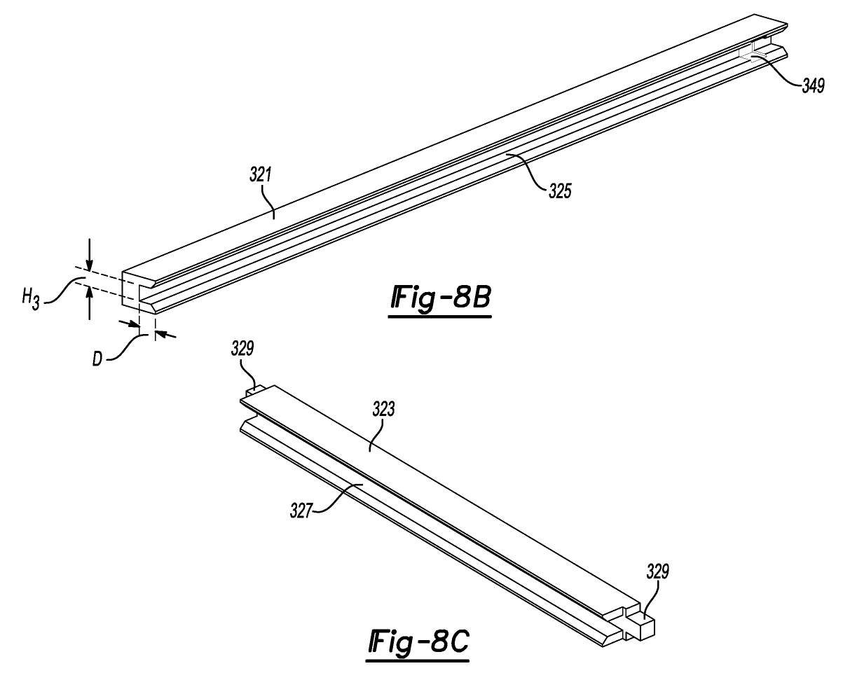

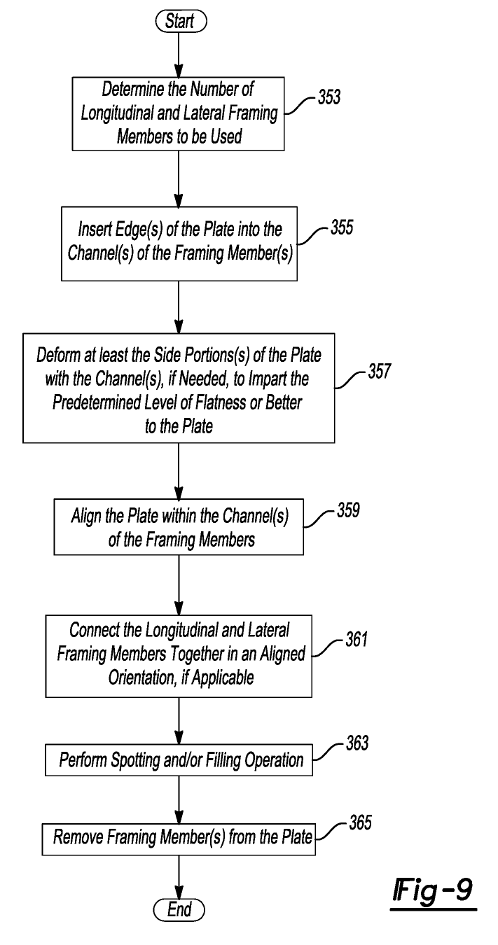

In some embodiments, a flattening device 322, as shown in FIGS. 8A-8C, can use framing members to frame an entirety or a portion of microplate 326 and impart a level of flatness that is equal to or better than a predetermined value. Flattening device 322 can comprise a pair of longitudinal framing members 321 and a pair of lateral framing members 323. Framing members 321, 323 can have respective channels 325, 327 therein which are adapted to receive sidewalls 332 of microplate 326. Channels 325, 327 can be dimensioned to have an internal height H₃ that is slightly larger than a nominal thickness H₂ of sidewalls 332 of microplate 326. The height H₃ of channels 325, 327 can cause microplate 326 to have a level of flatness equal to or better than the predetermined level of flatness. In some embodiments, height H₃ can be equal to the nominal thickness H₂+500 microns or less. In some embodiments, height H₃ can impart a level of flatness of the nominal thickness H₂±250 microns. Channels 325, 327 can provide an interference fit with sidewalls 332 of microplate 326.

One or more framing members 321, 323 can be used to impart the predetermined level of flatness to microplate 326. The number of framing members 321, 323 that are used can vary based on a variety of factors. One factor is the degree to which microplate 326 deviates from the predetermined level of flatness and how that deviation occurs. For example, if the deviation is along a longitudinal side of microplate 326, it may be possible to achieve the predetermined level of flatness with the use of a single longitudinal framing member 321. When microplate 326 deviates from the predetermined level of flatness along a lateral side, it may be possible for a single lateral framing member 323 to be used to impart the predetermined level of flatness to microplate 326. In some embodiments, two or more framing members 321, 323 can be used to impart the predetermined level of flatness.

In some embodiments, a longitudinal framing member 321 and a lateral framing member 323 are used to impart the predetermined level of flatness to microplate 326. To facilitate the use of a longitudinal framing member 321 in conjunction with a lateral framing member 323, longitudinal and lateral framing members 321, 323 can be configured to engage with one another in a fixed orientation, such as orthogonal to one another. To accomplish this, lateral framing members 323 can have end portions 329 that can be dimensioned to fit within channels 325 in longitudinal framing members 321. End portions 329 can be dimensioned to provide an interference fit with channels 325. The interference fit can allow lateral framing members 323 to be secured to longitudinal framing members 321 and can thereby facilitate the imparting of a desired level of flatness equal to or better than a predetermined level to a microplate 326.

In some embodiments, end portions 329 can be configured to allow lateral framing members 323 to be secured to longitudinal framing members 321 in a desired position. Alignment features can be used to align a lateral framing member 323 in a specific position relative to a longitudinal framing member 321. For example, as shown in FIG. 8B, longitudinal framing members 321 can include a notch 349 that has a height larger than height H₃ of channel 325 and can be dimensioned to receive an end portion 329 having a height complementary to notch 349. The interaction between notch 349 and end portion 329 can position lateral framing member 323 in a desired longitudinal position relative to longitudinal framing member 321. The positioning of lateral framing member 323 relative to longitudinal framing member 321 can facilitate the precise alignment of a microplate 326 therein when both longitudinal and lateral framing members 321, 323 are used in conjunction with one another.

In some embodiments, longitudinal framing members 321 can include a stop or projection in channel 325 at a desired longitudinal position that can engage with a corner or side of microplate 326 to provide a desired relative orientation between longitudinal framing member 321 and microplate 326.

Framing members 321, 323 can have precise external dimensions that can allow an external surface of framing members 321, 323 to be used to index a position of a microplate 326 disposed therein relative to an instrument deck. To facilitate using an exterior surface of framing members 321, 323 as an indexing feature, a depth D (only shown in FIG. 8B) of channels 325, 327 can be dimensioned to provide a precise distance from a sidewall 332 of a microplate 326 disposed therein. A precise depth D can allow an instrument deck to index off the exterior surface of the framing member opposite channel 325, 327. It should be appreciated, however, that other indexing features, such as pins, projections, and recesses, by way of non-limiting example, can be included on framing members 321, 323 to facilitate indexing of a microplate 326 disposed therein relative to an instrument deck.

The interaction between sidewalls 332 of microplate 326 and channels 325, 327 can force portions of microplate 326 to conform to the straight and rigid nature of the channels and can thereby impart a level flatness equal to or better than a predetermined value. The framing members 321, 323 can be made from a variety of materials and can be more rigid than microplate 326. For example, suitable materials include steel, aluminum, or other metals or materials, such as polymers.

Referring to FIG. 9, a method of using one or more framing members 321, 323 to impart a predetermined level of flatness or better to microplate 326 is shown. To use framing members 321, 323 to impart a desired level of flatness to microplate 326, the process begins with the determination of the number of longitudinal framing members 321 and lateral framing members 323 that are to be used, as indicated in block 353. As stated above, one or more longitudinal framing members 321 and/or one or more lateral framing members 323 can be utilized. With the number of framing members ascertained, the edges of microplate 326 are inserted into the channels 325, 327 of the longitudinal and lateral framing members 321, 323, respectively, as indicated in block 355.

During the insertion process, at least the portions of microplate 326 adjacent the inserted edges are deformed with channels 325, 327, if needed, to impart the predetermined level of flatness or better to microplate 326, as indicated in block 357. The rigid nature of framing members 321, 323 and of the associated channels 325, 327 can cause the side portions of microplate 326 to deform therein.

Also during the insertion process, microplate 326 is aligned within channels 325, 327 of framing members 321, 323, as indicated in block 359. The aligning can include engaging the sidewalls 332 fully within the ends of channels 325, 327 and/or with alignment features within channels 325, 327.

If both a longitudinal framing member 321 and a lateral framing member 323 are being used to impart the predetermined level of flatness to microplate 326, the framing members 321, 323 are connected together in an aligned orientation, as indicated in block 361. The aligned orientation can be achieved by engaging end portions 329 of lateral framing member 323 with the appropriate feature, such as notch 349, in longitudinal framing member 321.

With the longitudinal and lateral framing members 321, 323, as applicable, connected to one another and microplate 326 disposed therein and having been imparted with the predetermined level of flatness, microplate 326 and the framing members 321, 323 can be positioned on the instrument deck and the spotting and/or filling operation performed, as indicated in block 363. After the spotting and/or filling operation is performed, microplate 326 can be removed from framing members 321, 323, as applicable, as indicated in block 365.

Thus, one or more framing members 321, 323, either singularly or in combination, can be used to impart a predetermined level of flatness to a microplate 326. The imparting of the predetermined level of flatness can facilitate a spotting and/or filling operation performed on microplate 326 when disposed on an instrument deck. Framing members 321, 323 can be used to precisely align the flattened microplate 326 on the instrument deck.

While the present teachings are described in conjunction with various embodiments, it is not intended that the present teachings be limited to such embodiments. On the contrary, the present teachings encompass various alternatives, modifications, and equivalents, as will be appreciated by those of skill in the art. For example, the various features and components of the flattening devices disclosed herein can be mixed or interchanged with one another, as desired, to provide the associated benefits and/or advantages of using such features or components. Such variations are not to be regarded as a departure from the spirit and scope of the invention.

What is claimed is:

1. A microplate flattener for imparting a predetermined level of flatness to a microplate, the microplate flattener comprising:
a rigid member having a supporting surface thereon with a flatness of at least a predetermined value; and
a pair of opposing channels having openings facing one another, said pair of opposing channels each extending along a length of said rigid member and extending outwardly from said supporting surface, said pair of opposing channels engagable with the microplate and dimensioned to impart the predetermined level of flatness upon the microplate.

2. The microplate flattener according to claim 1, further comprising:
an alignment pin projecting outwardly from said supporting surface.

3. The microplate flattener according to claim 2, further comprising:
a retaining mechanism having a spring member disposed in a cavity in said rigid member and a ball member moveably disposed in said cavity, said ball member being biased by said spring member to protrude above said supporting surface.

4. The microplate flattener according to claim 1, wherein said pair of opposing channels comprises channels integrally formed with said rigid member such that said supporting surface defines a lower wall of each of said pair of opposing channels.

5. The microplate flattener according to claim 4, wherein a side wall of said rigid member extends beyond said supporting surface to form a back wall of each of said pair of opposing channels.

6. The microplate flattener according to claim 1, wherein each of said pair of opposing channels extends along an entire longitudinal length of said rigid member.

7. The microplate flattener according to claim 1, further comprising at least one alignment feature on said supporting surface engagable with the microplate operable to align the microplate relative to said supporting surface

8. The microplate flattener according to claim 1, wherein said pair of opposing channels comprises U-shaped channels.

9. The microplate flattener according to claim 1, wherein said pair of opposing channels comprises channels having an internal height that imparts at least said predetermined value of flatness to the microplate disposed therein and supported by said supporting surface.

10. The microplate flattener according to claim 1, wherein said pair of opposing channels comprises channels having an internal height greater than a nominal thickness of the microplate.

11. The microplate flattener according to claim 1, wherein said predetermined level of flatness comprises 500 microns.

12. The microplate flattener according to claim 1, wherein said predetermined level of flatness comprises a nominal thickness of 250 microns or less.

13. The microplate flattener according to claim 1, wherein said rigid member comprises an indexing feature allowing precise positioning on an instrument deck.

14. The microplate flattener according to claim 1, wherein said supporting surface and said pair of opposing channels are sized to receive the microplate having dimensions of about 127 mm in length and about 85 mm in width.

15. A system for improving the flatness of a microplate, the system comprising:
a first rigid framing member having a rigidity greater than a rigidity of the microplate; and
a channel in said first rigid framing member, said channel extending along a length of said first rigid framing member, said channel having an internal height dimensioned to have an interference fit with an edge of the microplate,
wherein said first rigid framing member imparts a predetermined level of flatness to the microplate when positioned in said channel.

16. The system according to claim 15, further comprising:
a second rigid framing member having a channel and a first connecting feature disposed on an end of said second rigid framing member, said first connecting feature engaging said channel of said first rigid framing member to secure said first rigid framing member to said second rigid framing member.

17. The system according to claim 16, wherein said first rigid framing member comprises a notch in its associated channel, said notch receiving said connecting feature of said second rigid framing member to secure said first and second rigid framing members together.

18. The system according to claim 16, wherein said connecting feature and said channel of said first rigid framing member comprise an interference fit that secures said first and second rigid framing members together.

19. The system according to claim 16, wherein said first and second rigid framing members are secured together in an orthogonal orientation.

20. The system according to claim 15, further comprising:
a second rigid framing member identical to said first rigid framing member having a channel;
third and forth rigid framing members each having a channel and a connecting feature disposed on at an end thereof, said connecting features engaging said channels of said first and second rigid framing members and securing said first, second, third, and forth rigid framing members together around a periphery of the microplate.

21. The system according to claim 15, wherein said channel is sized to receive the microplate and form an interference fit therewith.

22. The system according to claim 15, wherein said predetermined level of flatness comprises a nominal thickness of 250 microns or less.

23. A method of flattening a microplate for a spotting or filling operation, the method comprising:
(a) positioning the microplate in a channel of a rigid member having a rigidity greater than a rigidity of the microplate;
(b) deforming at least a portion of the microplate with said channel thereby imparting a flatness of at least a predetermined value; and
(c) maintaining the microplate in said channel during a subsequent spotting or filling operation.

24. The method according to claim 23, further comprising aligning the microplate relative to said rigid member with one or more alignment features.

25. The method according to claim 23, further comprising aligning the microplate relative to said rigid member with a first alignment feature that comprises a pin projecting from said rigid member.

26. The method according to claim 23, wherein said maintaining the microplate in said channel comprises retaining the microplate in an aligned position relative to said rigid member with a detent mechanism.

27. The method according to claim 23, wherein said positioning the microplate in said channel of said rigid member comprises:
aligning opposing sides of the microplate with opposing channels on said rigid member that extend from a supporting surface of said rigid member; and
sliding the microplate along said supporting surface with said sides of the microplate engaged with and sliding into said channels, and
wherein said deforming said at least a portion of the microplate with said channel comprises deforming at least a portion of the microplate with said channels as the microplate is slid therein.

28. The method according to claim 23, wherein said positioning the microplate comprises positioning side edges of the microplate into channels in a plurality of individual rigid members.

29. The method according to claim 28, further comprising securing adjacent ones of said individual rigid members together in an aligned orientation.

30. The method according to claim 29, wherein said securing adjacent ones of said individual rigid members together comprises inserting connecting features on an end of one of said adjacent framing members into said channel of the other one of said adjacent framing members.

31. The method according to claim 30, wherein said securing adjacent ones of said individual rigid members together comprises inserting said connecting feature into a notch in said channel of the other one of said adjacent framing members.

32. The method according to claim 28, wherein said positioning side edges of the microplate into channels in a plurality of individual rigid members comprises positioning side edges of the microplate into channels in four individual rigid members that surround the microplate.

33. The method according to claim 23, wherein said rigid member comprises a plurality of rigid framing members each having a channel therein having a flatness of at least said predetermined value, said positioning comprises positioning said rigid framing members along at least two edges of the microplate with said edges disposed in said channels, and said deforming comprises securing the microplate to said rigid framing members with an interference fit between said side edges and said channels with said interference fit imparting said flatness of at least said predetermined value to the microplate.

34. The method according to claim 33, further comprising attaching adjacent ends of said rigid framing members together.

35. The method according to claim 33, further comprising performing a spotting or filing operation on the microplate.

36. The method according to claim 23, further comprising positioning said rigid member and the microplate therein to an instrument deck and indexing a position of the microplate relative to said instrument deck using a surface of said rigid member.
